(19) United States
(12) Patent Application Publication
(10) Pub. No.: US 2010/0072190 A1
(43) Pub. Date: Mar. 25, 2010

(54) APPARATUS AND METHOD FOR AUTOMATICALLY SHUTTING OFF A BURNER OF A STOVE OR OVEN

(75) Inventor: Kevin M. Crucs, Copley, OH (US)

Correspondence Address: HAHN LOESER & PARKS, LLP, One GOJO Plaza, Suite 300, AKRON, OH, 44311-1076, US

(73) Assignee: CRUCS HOLDINGS, Copley, OH (US)

(21) Appl. No.: 12/236,109

(22) Filed: Sep. 23, 2008

(51) Int. Cl. H05B 1/02; H01H 43/00; F23N 5/00; F24C 3/12

(52) U.S. Cl. 219/492; 307/141; 431/6; 126/42

(57) ABSTRACT

A safety apparatus for a stove or oven and a method of operation thereof. The safety apparatus facilitates the method of turning on a burner of the stove or oven and automatically counting over a time interval in response to turning on the burner. The method further includes automatically stopping a flow of electrical current or combustible gas to the burner in response to the counting reaching an end of the time interval.

### INCORPORATION BY REFERENCE/RELATED APPLICATIONS

U.S. Pat. No. 4,849,951 issued on Jul. 18, 1989 is incorporated herein by reference in its entirety.

### TECHNICAL FIELD

Certain embodiments of the present invention relate to stoves and ovens. More particularly, certain embodiments relate to stoves and ovens that disable themselves as a safety feature.

### BACKGROUND

Gas or electric stoves and ovens are found in most homes and apartments, and also in some office buildings, for example. Many of these stoves and ovens have built-in timers that may be set by a user to go off by, for example, beeping after a set time interval has elapsed. Such beeping reminds the user to check what they are cooking on the stove or in the oven and/or to turn the burner(s) off. For example, a user may forget that the stove or oven is in use because the user may have an illness such as Alzheimer's disease, or the user may be mentally impaired in some other manner. However, if a user does not hear the timer beep, then the burner remains on and the food may become overcooked or burnt, and a fire may start. A user may not hear the timer beep because the user may be in a different room in the house, or because the user may be hearing-impaired, for example.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention comprises a method of automatically shutting off an electric burner of a stove or oven. The method includes turning on an electric burner and automatically counting over time interval in response to turning on the electric burner. The method further includes automatically stopping a flow of electrical current to the electric burner in response to the counting reaching an end of the time interval. The method may further include selecting the time interval from a plurality of preset time intervals. The method may also include entering the time interval.

Automatically stopping the flow of electrical current to the electric burner may be accomplished by automatically opening a conductive electrical path to the electric burner in response to the counting reaching an end of the time interval. The method may further include re-closing the conductive electrical path in response to again turning on the electric burner.

Automatically stopping the flow of electrical current to the electric burner may be accomplished by automatically setting an electrical switch to a non-conductive position in response to the counting reaching an end of the time interval. The method may further include resetting the electrical switch to a conductive position in response to again turning on the electric burner.

Another embodiment of the present invention comprises a method of automatically shutting off a gas burner of a stove or oven. The method includes turning on a gas burner and automatically counting over a time interval in response to turning on the gas burner. The method further includes automatically stopping a flow of combustible gas to the gas burner in response to the counting reaching an end of the time interval. The method may further include selecting the time interval from a plurality of preset time intervals. The method may also include entering the time interval.

Automatically stopping the flow of combustible gas to the gas burner may be accomplished by automatically closing a gas flow path to the gas burner in response to the counting reaching an end of the time interval. The method may further include re-opening the gas flow path in response to again turning on the gas burner.

Automatically stopping the flow of combustible gas to the gas burner may be accomplished by automatically setting a gas valve to a non-flowing position in response to the counting reaching an end of the time interval. The method may further include re-setting the gas valve to a flowing position in response to again turning on the gas burner.

A further embodiment of the present invention comprises, in a stove or oven for providing an electric current to an electric burner, an improvement comprising a safety apparatus. The safety apparatus includes means for turning on an electric burner and means for automatically counting over a time interval in response to activating the means for turning on the electric burner. The safety apparatus also includes means for automatically stopping a flow of electrical current to the electric burner in response to the means for automatically counting reaching an end of the time interval. The safety apparatus may further include means for selecting the preset interval from a plurality of preset time intervals. The safety apparatus may further include means for entering the time interval.

The means for automatically stopping a flow of electrical current to the electric burner may include means for automatically opening a conductive electrical path to the electric burner in response to the means for automatically counting reaching an end of the time interval. The safety apparatus may further include means for re-closing the conductive electrical path in response to re-activating the means for turning on the electric burner.

The means for automatically stopping a flow of electrical current to the electric burner may include an electrical switch and means for automatically setting the electrical switch to a non-conductive position in response to the means for automatically counting reaching an end of the time interval. The safety apparatus may further include means for resetting the electrical switch to a conductive position in response to re-activating the means for turning on the electric burner.

A further embodiment of the present invention comprises, in a stove or oven for providing gas to a gas burner, an improvement comprising a safety apparatus. The safety apparatus includes means for turning on a gas burner and means for automatically counting over a time interval in response to activating the means for turning on the gas burner. The safety apparatus also includes means for automatically stopping a flow of combustible gas to the gas burner in response to the means for automatically counting reaching an end of the time interval. The safety apparatus may further include means for selecting the time interval from a plurality of preset time intervals. The safety apparatus may also include means for entering the time interval.

The means for automatically stopping a flow of combustible gas to the gas burner may include means for automatically closing a gas flow path to the gas burner in response to the means for automatically counting reaching an end of the time interval. The safety apparatus may further include means for re-opening the gas flow path in response to re-activating the means for turning on a gas burner.

The means for automatically stopping a flow of gas to the gas burner may include a gas valve and means for automatically setting the gas valve to a non-flowing position in response to the means for automatically counting reaching an end of the time interval. The safety apparatus may further include means for resetting the gas valve to a flowing position in response to re-activating the means for turning on a gas burner.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a flowchart of an embodiment of a method of automatically shutting off a gas burner of a stove or oven;

FIG. 2 illustrates a first embodiment of an improvement to a stove or oven for providing gas to a gas burner where the improvement comprises a safety apparatus that facilitates the method of FIG. 1;

FIG. 3 illustrates a second embodiment of an improvement to a stove or oven for providing gas to a gas burner where the improvement comprises a safety apparatus that facilitates the method of FIG. 1;

FIG. 4 illustrates a flowchart of an embodiment of a method of automatically shutting off an electric burner of a stove or oven;

FIG. 5 illustrates a first embodiment of an improvement to a stove or oven for providing electric current to an electric burner where the improvement comprises a safety apparatus that facilitates the method of FIG. 4; and

FIG. 6 illustrates a second embodiment of an improvement to a stove or oven for providing an electric current to an electric burner where the improvement comprises a safety apparatus that facilitates the method of FIG. 4.

### DETAILED DESCRIPTION

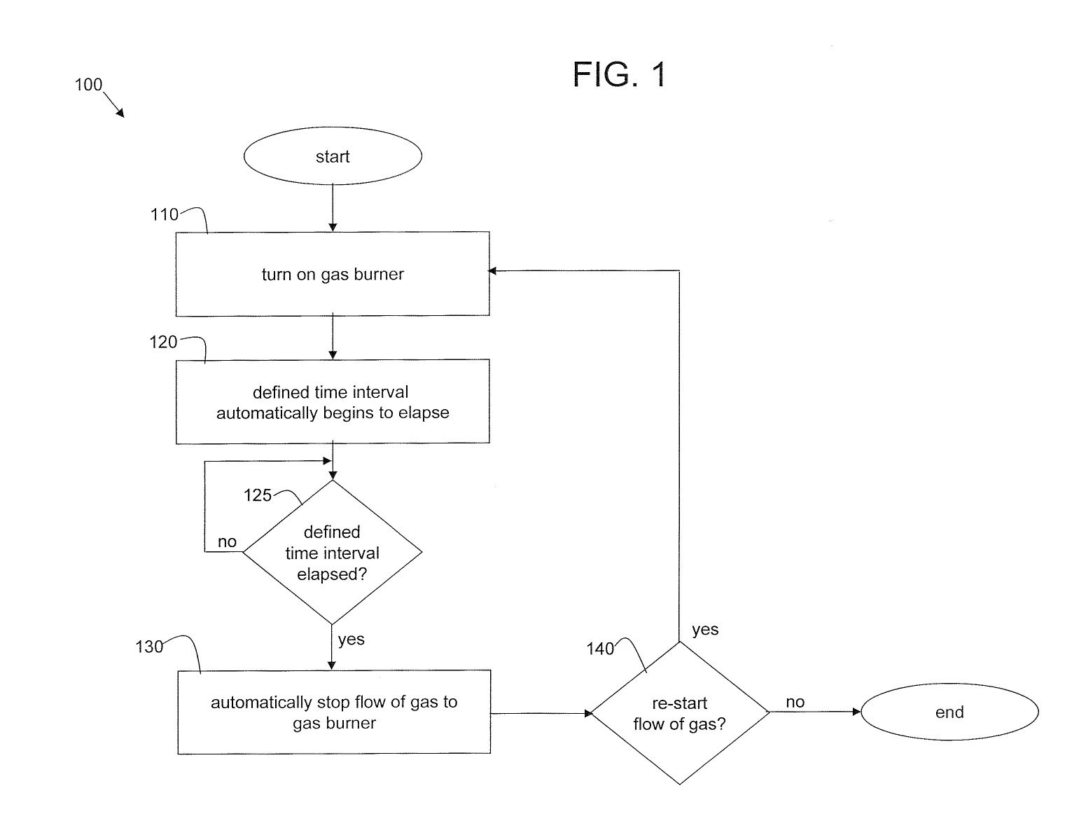

FIG. 1 illustrates a flowchart of an embodiment of a method 100 of automatically shutting off a gas burner of a stove or oven. The gas stove or oven may be a stove or oven that operates using combustible natural gas or propane, for example. In step 110, a user turns on a gas burner. The gas may be ignited by an electric spark starter capability or by a pilot light at the burner, for example. In step 120, a defined time interval automatically begins to elapse in response to the gas burner being turned on. In step 125, if the defined time interval has elapsed then, in step 130, a flow of gas to the gas burner is automatically turned off in response to the elapsed time interval. In step 140, if it is desired to restart the flow of gas to the gas burner, the method proceeds back to step 110.

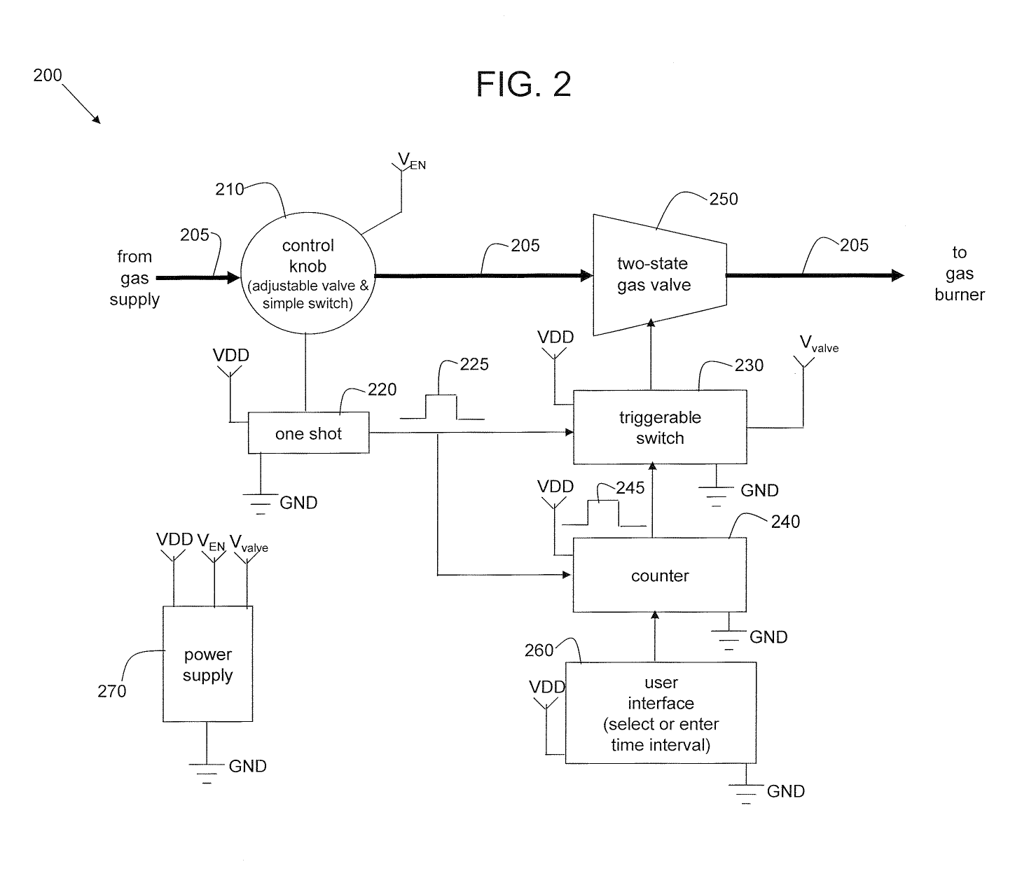

FIG. 2 illustrates a first embodiment of an improvement to a stove or oven for providing gas to a gas burner where the improvement comprises a safety apparatus 200 that facilitates the method 100 of FIG. 1. The safety apparatus 200 includes a combination mechanism 210 including a control knob, an adjustable gas valve, and a simple electrical switch. Mechanically turning or rotating the knob of the mechanism 210 controls the adjustable gas valve and the simple electric switch of the mechanism 210. The safety apparatus 200 also includes a one-shot device 220, a triggerable switch 230, a digital counter 240, and a two-state (fully on or fully off) gas valve 250. During normal operation, the flow of gas follows a path 205 from a gas supply through the adjustable gas valve of the mechanism 210, through the two-state gas valve 250, and to a gas burner.

A user may turn or rotate the knob of the mechanism 210 to initiate the turning on of the gas burner as is described herein. The further a user rotates the knob of the mechanism 210, the more the adjustable gas valve of the mechanism 210 opens. In this way, a user is able to adjust the amount of gas flowing between the gas supply and the gas burner and, therefore, the level of the resultant flame at the gas burner and the amount of heat being generated by the burner. Also, when the user rotates the knob of the mechansim 210 past a first position, the simple electric switch of the mechanism 210 closes, providing an enabling voltage V_{EN} to the one-shot device 220.

When the one-shot device 220 is enabled by the enabling voltage V_{EN} in response to the user turning the knob of the mechansim 210, the one-shot device 220 outputs a trigger pulse 225 to the triggerable switch 230 and the digital counter 240. The trigger pulse 225 causes the triggerable switch 230 to turn on or close, allowing a voltage Vᵥₐₗᵥₑ to be applied to an input of the two-state gas valve 250. The voltage Vᵥₐₗᵥₑ causes the two-state gas valve 250 to transition from a closed (non-flowing) state to an open (flowing) state, allowing gas from the adjustable gas valve to pass through the two-state gas valve 250 and on to the gas burner. When the gas reaches the gas burner, the gas is ignited by, for example, an electric spark starter or a pilot light and, therefore, the gas burner is turned on.

In accordance with an embodiment of the present invention, the two-state gas valve 250 has an electromagnet inside which causes the gas valve 250 to open when a small charge or voltage Vᵥₐₗᵥₑ is applied at the electromagnet. Other types of charge or voltage controlled gas valves may be possible as well.

The trigger pulse 225 also triggers the digital counter 240 to start counting over a defined time interval. In accordance with an embodiment of the present invention, the safety apparatus 200 includes a user interface 260 operatively connected to the digital counter 240, allowing a user to select or enter a desired time interval. The desired time interval may be ten minutes, for example. The user interface 260 may allow time intervals from several seconds to several hours to be selected or entered, for example. The user interface may include, for example, a multi-position knob or switch, or a numeric touch pad or touch screen, in accordance with certain embodiments of the present invention.

When the digital counter 240 finishes counting over the time interval, the digital counter 240 outputs a trigger signal 245 to the triggerable switch 230, causing the triggerable switch 230 to turn off or open, preventing the voltage Vᵥₐₗᵥₑ from being applied to the input of the two-state gas valve 250. As a result, the two-state gas valve 250 closes and gas stops flowing to the gas burner, effectively shutting off the gas burner.

The knob of the mechanism 210 remains in an “on” position and the adjustable gas valve of the mechanism 210 remains at least partially open, although the two-state gas valve 250 prevents gas from reaching the gas burner. In order for the gas burner to again be turned on, a user turns the knob of the mechanism 210 back to an “off” position and again turns or rotates the knob of the mechanism 210 to again initiate turning on of the gas burner as previously described herein. Enabling the counter 240 via the one-shot device 220 ensures that the supply of gas to the gas burner will cease after the elapsed time, whether the gas at the gas burner has actually ignited or not.

As an example, an elderly woman may turn on a burner of her oven in order to bake a pie. Having turned on the oven, the oven, having the safety apparatus of FIG. 2 as described herein, has a time interval of 30 minutes selected from which the counter 240 is counting down. The 30 minutes may have been selected by the elderly woman via the user interface 260 at the time of preparing the pie, or the 30 minutes may have been previously selected sometime earlier (e.g., yesterday when the elderly woman baked a cake). The elderly woman, having turned on the gas oven, proceeds to go upstairs to her bedroom and lies down to take a nap, forgetting that she put the pie in the oven. However, after the 30 minutes has elapsed, the burner of the oven automatically turns off, ensuring that the pie does not burn and that a fire does not start.

Certain devices of the safety apparatus 200 may require electric power to be applied in order to function. For example, the one shot device 220, the triggerable switch 230, the counter 240, and the user interface 260 may each require a voltage VDD and a ground GND to be applied, as shown in FIG. 2, in order to operate as described herein. The voltages VDD, V_{EN}, Vᵥₐₗᵥₑ, and the ground GND may be provided by a power supply 270 which may be part of the safety apparatus 200.

In accordance with an embodiment of the present invention, the power supply 270 may include one or more batteries along with other circuitry for forming the direct current (DC) voltages VDD, V_{EN}, and Vᵥₐₗᵥₑ with respect to a ground potential GND. In accordance with another embodiment of the present invention, the power supply 270 may include a power regulator/converter that takes in alternating current (AC) from, for example, a standard 220 VAC power source or a 110 VAC power source and converts the AC voltage to DC voltages VDD, V_{EN}, and Vᵥₐₗᵥₑ. For example, VDD may be 5.0 VDC, V_{EN} may be 3.3 VDC, and Vᵥₐₗᵥₑ may be 1.0 VDC, in accordance with an embodiment of the present invention.

In accordance with an embodiment of the present invention, the various devices 220, 230, 240, and 270 may be mounted on a printed circuit board (PCB) which provides the various electrical interfaces between the devices. The PCB with the mounted devices, the two-state gas valve 250, and the adjustable gas valve and the simple electrical switch of the combination mechanism 210 may all be mounted substantially internally to a gas stove or oven. The control knob of the combination mechanism 210 and the user interface 260 may be mounted substantially externally to the gas stove or oven to allow for user access.

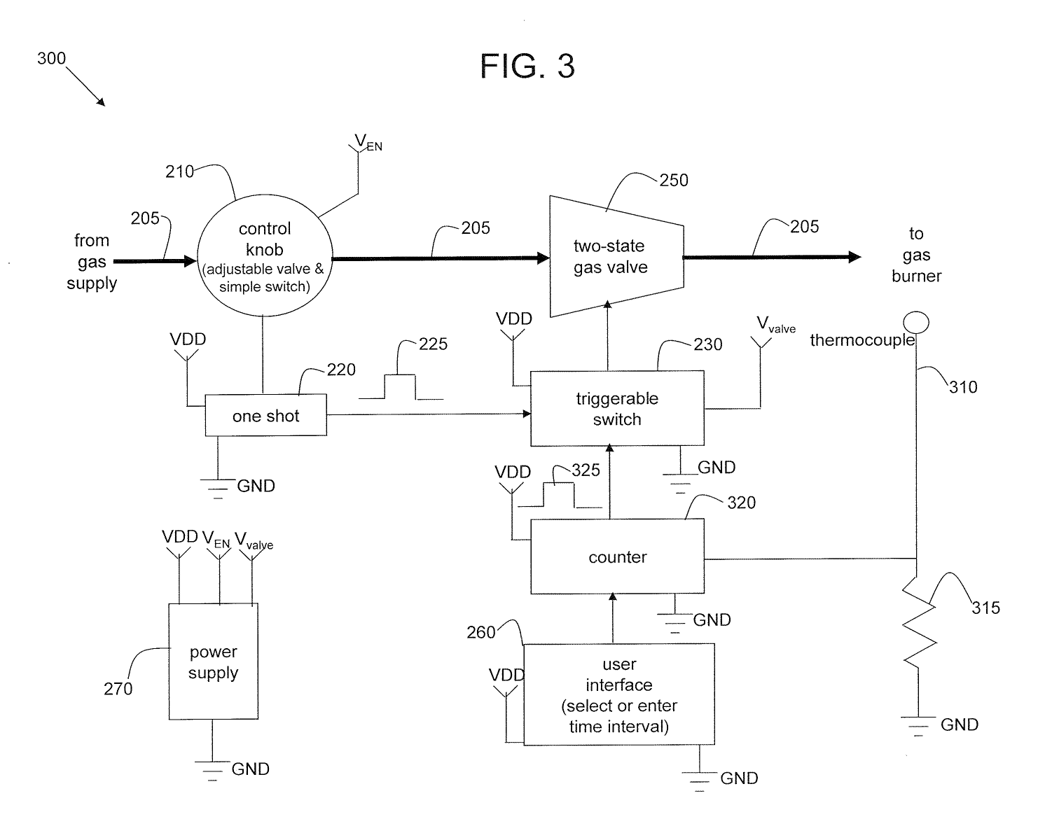

FIG. 3 illustrates a second embodiment of an improvement to a stove or oven for providing gas to a gas burner where the improvement comprises a safety apparatus 300 that facilitates the method 100 of FIG. 1. The safety apparatus 300 is very similar to the safety apparatus 200 of FIG. 2 and functions very similarly except for certain differences which are described herein.

The safety apparatus 300 includes a combination mechanism 210 including a contorl knob, an adjustable gas valve, and a simple electrical switch. Mechanically turning or rotating the knob of the mechanism 210 controls the adjustable gas valve and the simple electric switch of the mechanism 210. The safety apparatus 200 also includes a one-shot device 220, a triggerable switch 230, a digital counter 320, and a two-state (fully on or fully off) gas valve 250. During normal operation, the flow of gas follows a path 205 from a gas supply through the adjustable gas valve of the mechanism 210, through the two-state gas valve 250, and to a gas burner.

A user may turn or rotate the knob of the mechanism 210 to initiate the turning on of the gas burner as is described herein. The further a user rotates the knob of the mechanism 210, the more the adjustable gas valve of the mechanism 210 opens. In this way, a user is able to adjust the amount of gas flowing between the gas supply and the gas burner and, therefore, the level of the resultant flame at the gas burner and the amount of heat being generated by the burner. Also, when the user rotates the knob of the mechansim 210 past a first position, the simple electric switch of the mechanism 210 closes, providing an enabling voltage V_{EN} to the one-shot device 220.

When the one-shot device 220 is enabled by the enabling voltage V_{EN} in response to the user turning the knob of the mechansim 210, the one-shot device 220 outputs a trigger pulse 225 to the triggerable switch 230. The trigger pulse 225 causes the triggerable switch 230 to turn on or close, allowing a voltage Vᵥₐₗᵥₑ to be applied to an input of the two-state gas valve 250. The voltage Vᵥₐₗᵥₑ causes the two-state gas valve 250 to transition from a fully closed (non-flowing) state to a fully open (flowing) state, allowing gas from the adjustable gas valve of the mechanism 210 to pass through the two-state gas valve 250 and on to the gas burner. When the gas reaches the gas burner, the gas is ignited by, for example, an electric spark starter or a pilot light and, therefore, the gas burner is turned on.

In accordance with an embodiment of the present invention, the two-state gas valve 250 has an electromagnet inside which causes the gas valve 250 to open when a small charge or voltage (e.g., Vᵥₐₗᵥₑ) is applied at the electromagnet. Other types of charge or voltage controlled gas valves may be possible as well.

The safety apparatus 300 also includes a thermocouple device 310. The thermocouple device 310 is located at the gas burner and is capable of being heated by the gas burner. Thermocouple devices are well known in the art. The thermocouple device 310 is electrically connected to the counter 320 such that, when the thermocouple device 310 heats up due to the gas burner being ignited, an enabling voltage is produced at an enabling input to the digital counter 320 (e.g., across the resistor 315) and causes the digital counter 320 to start counting over a defined time interval. In accordance with an embodiment of the present invention, the thermocouple device 310 heats up relatively quickly (e.g., within 15 seconds of the gas igniting) and provides the enabling voltage to the digital counter 320.

In accordance with an embodiment of the present invention, the safety apparatus 200 includes a user interface 260 operatively connected to the digital counter 320, allowing a user to select or enter a desired time interval. The desired time interval may be five minutes, for example. The user interface 260 may allow time intervals from several seconds to several hours to be selected or entered, for example. The user interface 260 may include, for example, a multi-position knob or switch, or a numeric touch pad or touch screen, in accordance with certain embodiments of the present invention.

When the digital counter 320 finishes counting over the time interval, the digital counter 320 outputs a trigger signal 325 to the triggerable switch 230, causing the triggerable switch 230 to turn off or open, preventing the voltage Vᵥₐₗᵥₑ from being applied to the input of the two-state gas valve 250. As a result, the two-state gas valve 250 fully closes and gas stops flowing to the gas burner, effectively shutting off the gas burner.

The knob of the mechanism 210 remains in an “on” position and the adjustable gas valve of the mechanism 210 remains at least partially open, although the two-state gas valve 250 prevents gas from reaching the gas burner. In order for the gas burner to again be turned on, a user turns the knob of the mechanism 210 back to an “off” position and again turns or rotates the knob of the mechanism 210 to again initiate turning on of the gas burner as previously described herein. Instead of triggering the counter 320 off of the one-shot 220, enabling the counter 320 via the thermocouple device 310 ensures that the selected or entered time interval does not begin to elapse until heat transfer from the gas burner to, for example, a pot or pan resting on the gas burner has begun to take place (as indicated by the heating of the thermocouple device 310).

As an example, a college student may turn on a burner of a gas stove in a dorm room kitchen in order to heat a pan of soup. Having turned on the burner, the gas stove, having the safety apparatus of FIG. 3 as described herein, has a time interval of 10 minutes selected from which the counter 320 is counting down. The 10 minutes may have been entered by the college student via the user interface 260 at the time of preparing the pan of soup, or the 10 minutes may have been previously entered sometime earlier (e.g., three days ago when the college student made macaroni and cheese). The college student, having turned on the gas burner, proceeds to go outside and gets drawn into a game of ultimate frisbee, forgetting that he put on the pan of soup. However, after the 10 minutes has elapsed, the burner of the gas stove automatically turns off, ensuring that the soup does not boil away and that a fire does not start.

Again, certain devices of the safety apparatus 300 may require electric power to be applied in order to function. For example, the one shot device 220, the triggerable switch 230, the counter 320, and the user interface 260 may each require a voltage VDD and a ground GND to be applied, as shown in FIG. 3, in order to operate as described herein. The voltages VDD, V_{EN}, Vᵥₐₗᵥₑ, and the ground GND may be provided by a power supply 270 which may be part of the safety apparatus 300.

In accordance with an embodiment of the present invention, the power supply 270 may include one or more batteries along with other circuitry for forming the direct current (DC) voltages VDD, V_{EN}, and Vᵥₐₗᵥₑ with respect to a ground potential GND. In accordance with another embodiment of the present invention, the power supply 270 may include a power regulator/converter that takes in alternating current (AC) from, for example, a standard 220 VAC power source or a 110 VAC power source and converts the AC voltage to DC voltages VDD, V_{EN}, and Vᵥₐₗᵥₑ. For example, VDD may be 3.3 VDC, V_{EN} may be 2.5 VDC, and Vᵥₐₗᵥₑ may be 0.5 VDC, in accordance with an embodiment of the present invention.

Again, in accordance with an embodiment of the present invention, the various devices 220, 230, 320, and 270 may be mounted on a printed circuit board (PCB) which provides the various electrical interfaces between the devices. The PCB with the mounted devices, the two-state gas valve 250, and the adjustable gas valve and the simple electrical switch of the combination mechanism 210 may all be mounted substantially internally to a gas stove or oven. The control knob of the combination mechanism 210 and the user interface 260 may be mounted substantially externally to the gas stove or oven to allow for user access.

Having discussed embodiments of the present invention with respect to gas burners, other embodiments of the present invention may be applied to electric burners.

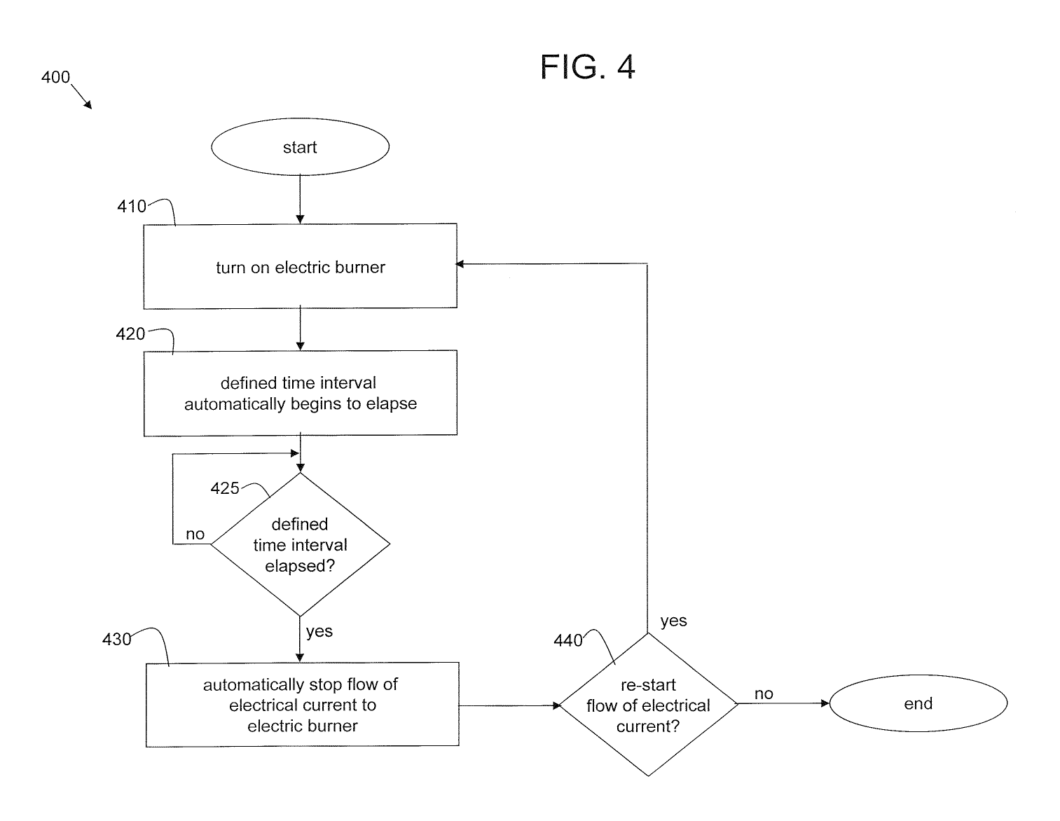

FIG. 4 illustrates a flowchart of an embodiment of a method 400 of automatically shutting off an electric burner of a stove or oven. The electric stove or oven is a stove or oven having at least one electric burner that operates using electricity (i.e., electrical current), for example. In step 410, a user turns on an electric burner. In step 420, a defined time interval automatically begins to elapse in response to the electric burner being turned on. In step 425, if the defined time interval has elapsed then, in step 430, a flow of electrical current to the electric burner is automatically turned off in response to the elapsed time interval. In step 440, if it is desired to restart the flow of electricity to the electric burner, the method proceeds back to step 410.

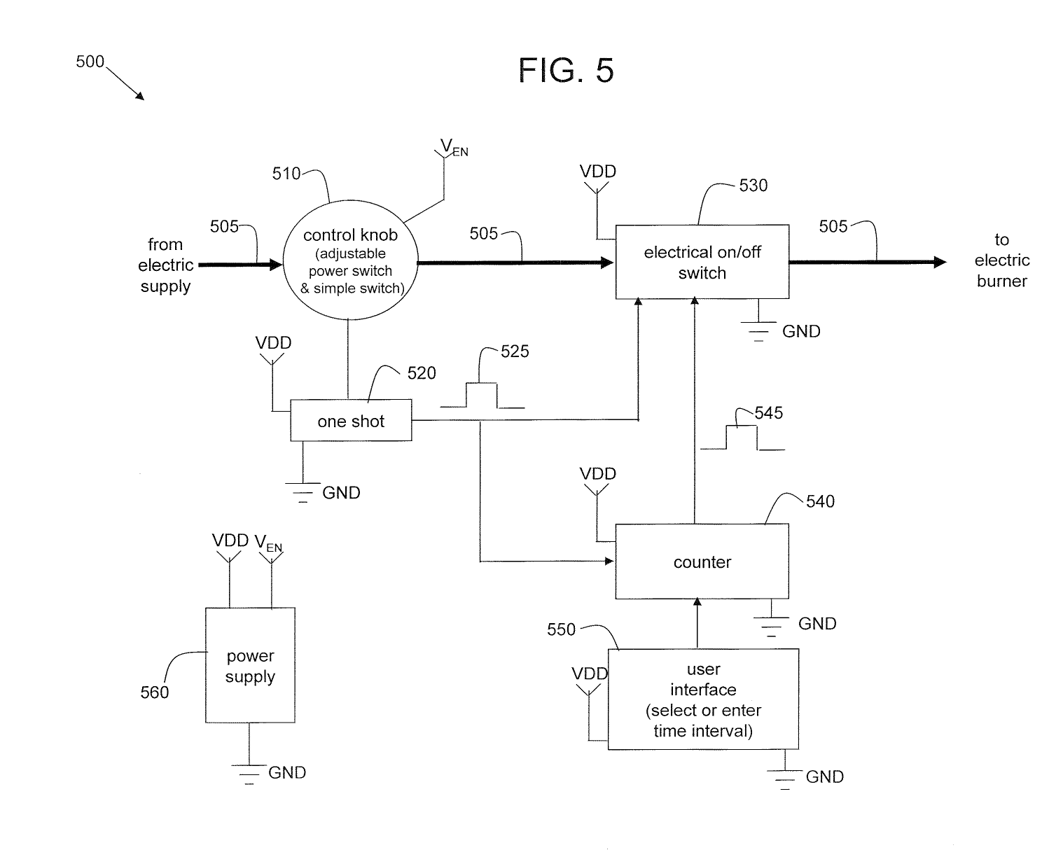

FIG. 5 illustrates a first embodiment of an improvement to a stove or oven for providing electric current to an electric burner where the improvement comprises a safety apparatus 500 that facilitates the method 400 of FIG. 4. The safety apparatus 500 includes a combination mechanism 510 including a control knob, an adjustable power switch, and a simple electrical switch. Mechanically turning or rotating the knob of the mechanism 510 controls the adjustable power switch and the simple electric switch of the mechanism 510. The safety apparatus 500 also includes a one-shot device 520, an electrical on/off switch 530, and a digital counter 540. During normal operation, the flow of electric current follows a path 505 between an electric supply and an electric burner through the adjustable power switch of the mechanism 510 and the electrical on/off switch 530.

A user may turn or rotate the knob of the mechanism 510 to initiate the turning on of the electric burner as is described herein. The further a user rotates the knob of the mechanism 510, the more the adjustable power switch of the mechanism 510 provides electric current. In this way, a user is able to adjust the amount of electric current flowing between the electric supply and the electric burner and, therefore, the amount of heat being generated by the burner. Also, when the user rotates the knob of the mechansim 510 past a first position, the simple electric switch of the mechanism 510 closes, providing an enabling voltage V_{EN} to the one-shot device 520.

When the one-shot device 520 is enabled by the enabling voltage V_{EN} in response to the user turning the knob of the mechansim 510, the one-shot device 520 outputs a trigger pulse 525 to the electrical on/off switch 530 and the digital counter 540. The trigger pulse 525 causes the electrical on/off switch 530 to turn on or close, allowing electric current to flow to the electric burner. When the electric current reaches the electric burner, the electric burner is turned on and the coils of the electric burner begin to heat up.

The trigger pulse 525 also triggers the digital counter 540 to start counting over a defined time interval. In accordance with an embodiment of the present invention, the safety apparatus 500 includes a user interface 550 operatively connected to the digital counter 540, allowing a user to select or enter a desired time interval. The desired time interval may be three minutes, for example. The user interface 550 may allow time intervals from several seconds to several hours to be selected or entered, for example. The user interface 550 may include, for example, a multi-position knob or switch, or a numeric touch pad or touch screen, in accordance with certain embodiments of the present invention.

When the digital counter 540 finishes counting over the time interval, the digital counter 540 outputs a trigger signal 545 to the electrical on/off switch 530, causing the electrical on/off switch 530 to turn off or open, preventing electrical current from reaching the electric burner, effectively shutting off the electric burner.

The knob of the mechanism 510 remains in an “on” position and the adjustable power switch of the mechanism 510 remains at least partially on, although the electrical on/off switch 530 prevents electric current from reaching the electric burner. In order for the electric burner to again be turned on, a user turns the knob of the mechanism 510 back to an “off” position and again turns or rotates the knob of the mechanism 510 to again initiate turning on of the electric burner as previously described herein. Enabling the counter 540 via the one-shot device 520 ensures that the supply of electric current to the electric burner will cease after the elapsed time, whether the heat produced by the electric burner is substantial or not.

As an example, a teenager may turn on a burner of an electric stove in order to heat up some left over food. Having turned on the burner, the electric stove, having the safety apparatus of FIG. 5 as described herein, has a time interval of 8 minutes selected from which the counter 540 is counting down. The 8 minutes may have been selected by the teenager via the user interface 550 at the time of heating up the left over food, or the 8 minutes may have been previously selected sometime earlier (e.g., yesterday when the mother of the teenager heated a pot of water for tea). The teenager, having turned on the electric burner, proceeds to get on the telephone in her bedroom and talk to a friend. However, after the 8 minutes has elapsed, the burner of the electric stove automatically turns off, ensuring that the left over food does not burn and that a fire does not start.

Certain devices of the safety apparatus 500 may require electric power to be applied in order to function. For example, the one shot device 520, the electrical on/off switch 530, the counter 540, and the user interface 550 may each require a voltage VDD and a ground GND to be applied, as shown in FIG. 5, in order to operate as described herein. The voltages VDD, V_{EN}, and the ground GND may be provided by a power supply 560 which may be part of the safety apparatus 500.

In accordance with an embodiment of the present invention, the power supply 560 may include one or more batteries along with other circuitry for forming the direct current (DC) voltages VDD and V_{EN} with respect to a ground potential GND. In accordance with another embodiment of the present invention, the power supply 560 may include a power regulator/converter that takes in alternating current (AC) from, for example, a standard 220 VAC power source or a 110 VAC power source and converts the AC voltage to DC voltages VDD and V_{EN}. For example, VDD may be 5.0 VDC, and V_{EN} may be 3.3 VDC, in accordance with an embodiment of the present invention.

In accordance with an embodiment of the present invention, the various devices 520, 530, 540, and 560 may be mounted on a printed circuit board (PCB) which provides the various electrical interfaces between the devices. The PCB with the mounted devices and the adjustable power switch and the simple electrical switch of the combination mechanism 510 may all be mounted substantially internally to an electric stove or oven. The control knob of the combination mechanism 510 and the user interface 550 may be mounted substantially externally to the electric stove or oven to allow for user access.

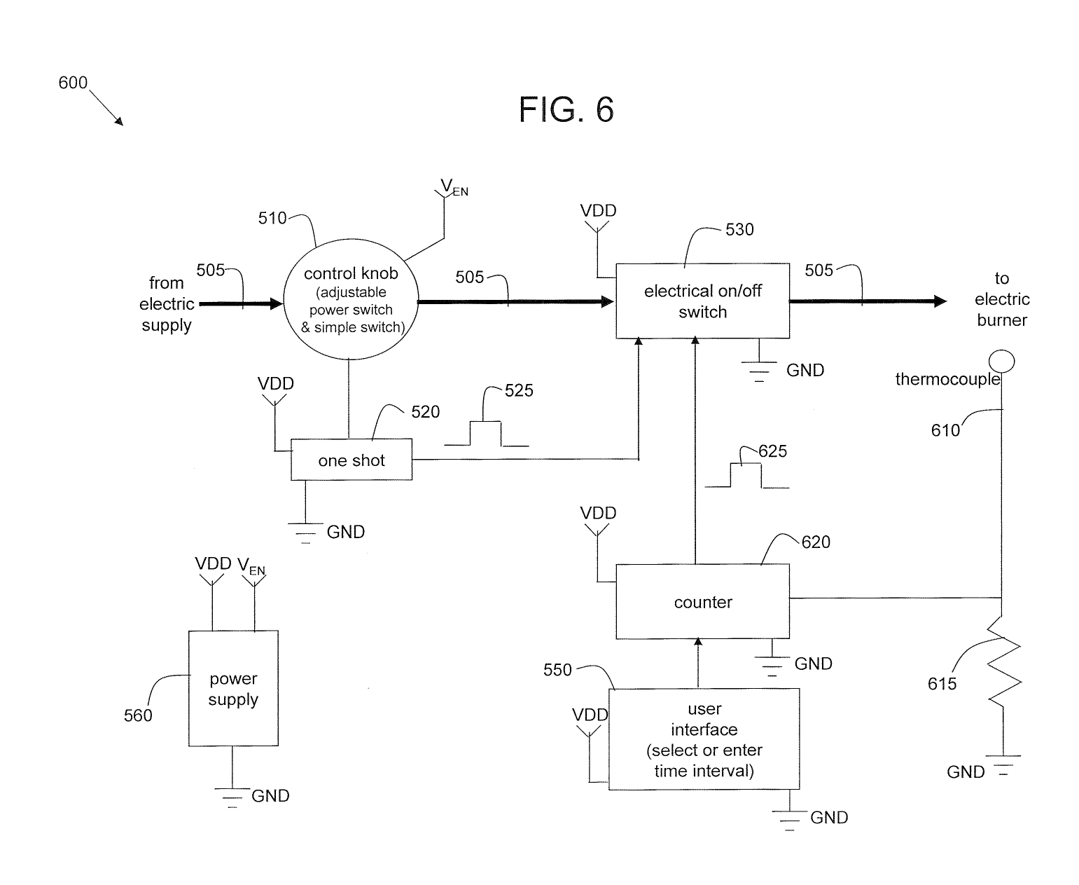

FIG. 6 illustrates a second embodiment of an improvement to a stove or oven for providing an electric current to an electric burner where the improvement comprises a safety apparatus 600 that facilitates the method 400 of FIG. 4. The safety apparatus 600 is very similar to the safety apparatus 500 of FIG. 5 and functions very similarly except for certain differences which are described herein.

The safety apparatus 600 includes a combination mechanism 510 including a control knob, an adjustable power switch, and a simple electrical switch. Mechanically turning or rotating the knob of the mechanism 510 controls the adjustable power switch and the simple electric switch of the mechanism 510. The safety apparatus 600 also includes a one-shot device 520, an electrical on/off switch 530, and a digital counter 620. During normal operation, the flow of electric current follows a path 505 between an electric supply and an electric burner through the adjustable power switch of the mechanism 510 and the electrical on/off switch 530.

A user may turn or rotate the knob of the mechanism 510 to initiate the turning on of the electric burner as is described herein. The further a user rotates the knob of the mechanism 510, the more the adjustable power switch of the mechanism 510 provides electric current. In this way, a user is able to adjust the amount of electric current flowing between the electric supply and the electric burner and, therefore, the amount of heat being generated by the burner. Also, when the user rotates the knob of the mechansim 510 past a first position, the simple electric switch of the mechanism 510 closes, providing an enabling voltage V_{EN} to the one-shot device 520.

When the one-shot device 520 is enabled by the enabling voltage V_{EN} in response to the user turning the knob of the mechansim 510, the one-shot device 520 outputs a trigger pulse 525 to the electrical on/off switch 530. The trigger pulse 525 causes the electrical on/off switch 530 to turn on or close, allowing electric current to flow to the electric burner. When the electric current reaches the electric burner, the electric burner is turned on and the coils of the electric burner begin to heat up.

The safety apparatus 600 also includes a thermocouple device 610. The thermocouple device 610 is located at the electric burner and is capable of being heated by the electric burner. Thermocouple devices are well known in the art. The thermocouple device 610 is electrically connected to the counter 620 such that, when the thermocouple device 610 heats up due to the electric burner being turned on, an enabling voltage is produced at an enabling input to the digital counter 620 (e.g., across the resistor 615) and causes the digital counter 620 to start counting over a defined time interval. In accordance with an embodiment of the present invention, the thermocouple device 610 heats up relatively quickly (e.g., within 30 seconds of the current flowing through the coils of the electric burner) and provides the enabling voltage to the digital counter 620.

In accordance with an embodiment of the present invention, the safety apparatus 600 includes a user interface 550 operatively connected to the digital counter 620, allowing a user to select or enter a desired time interval. The desired time interval may be four minutes, for example. The user interface 550 may allow time intervals from several seconds to several hours to be selected or entered, for example. The user interface 550 may include, for example, a multi-position knob or switch, or a numeric touch pad or touch screen, in accordance with certain embodiments of the present invention.

When the digital counter 620 finishes counting over the time interval, the digital counter 540 outputs a trigger signal 625 to the electrical on/off switch 530, causing the electrical on/off switch 530 to turn off or open, preventing electrical current from reaching the electric burner, effectively shutting off the electric burner.

The knob of the mechanism 510 remains in an “on” position and the adjustable power switch of the mechanism 510 remains at least partially on, although the electrical on/off switch 530 prevents electric current from reaching the electric burner. In order for the electric burner to again be turned on, a user turns the knob of the mechanism 510 back to an “off” position and again turns or rotates the knob of the mechanism 510 to again initiate turning on of the electric burner as previously described herein. Instead of triggering the counter 620 off of the one-shot 520, enabling the counter 620 via the thermocouple device 610 ensures that the selected or entered time interval does not begin to elapse until heat transfer from the electric burner to, for example, a pot or pan resting on the electric burner has begun to take place (as indicated by the heating of the thermocouple device 610).

Certain devices of the safety apparatus 600 may require electric power to be applied in order to function. For example, the one shot device 520, the electrical on/off switch 530, the counter 620, and the user interface 550 may each require a voltage VDD and a ground GND to be applied, as shown in FIG. 6, in order to operate as described herein. The voltages VDD, V_{EN}, and the ground GND may be provided by a power supply 560 which may be part of the safety apparatus 600.

In accordance with an embodiment of the present invention, the power supply 560 may include one or more batteries along with other circuitry for forming the direct current (DC) voltages VDD and V_{EN} with respect to a ground potential GND. In accordance with another embodiment of the present invention, the power supply 560 may include a power regulator/converter that takes in alternating current (AC) from, for example, a standard 220 VAC power source or a 110 VAC power source and converts the AC voltage to DC voltages VDD and V_{EN}. For example, VDD may be 5.0 VDC, and V_{EN} may be 3.3 VDC, in accordance with an embodiment of the present invention.

In accordance with an embodiment of the present invention, the various devices 520, 530, 620, and 560 may be mounted on a printed circuit board (PCB) which provides the various electrical interfaces between the devices. The PCB with the mounted devices and the adjustable power switch and the simple electrical switch of the combination mechanism 510 may all be mounted substantially internally to an electric stove or oven. The control knob of the combination mechanism 510 and the user interface 550 may be mounted substantially externally to the electric stove or oven to allow for user access.

In accordance with further alternative embodiments of the present invention, a mechanical timer, similar to that described in U.S. Pat. No. 4,849,951, may be integrated into the control knob 210 or 510. In such embodiments, the mechanical timer replaces the counter and user interface. The mechanical timer is driven by a spring which may be initially tensioned, and a prescribed time interval to be timed may be set by rotating a pointer or index mechanism from zero to a desired number of minutes. Such rotation further tensions the spring. The spring drives, through a gear train, an escape wheel which is able to rotate at a controlled speed by an escape lever disc that oscillates in and out of obstructing relationship with the escape wheel. The escape wheel may be a toothed member that rotates adjacent to the escape lever disc. A pair of posts on the escape lever disc may oscillate into and out of engagement with the teeth on the escape wheel thereby allowing the gear train to unwind until it returns to the zero setting.

Turning of the pointer or index of the control knob to a particular setting may initiate the one shot and, subsequently, the triggerable switch as in FIGS. 2 and 3, or may initiate the one shot and, subsequently, the electrical on/off switch as in FIGS. 5 and 6. When the mechanical timer of the control knob times out, a one shot may again be activated causing the triggerable switch or the electrical on/off switch to turn off the corresponding gas or electric burner. Other embodiments using an integrated mechanical timer are possible as well, in accordance with various other alternative embodiments of the present invention.

In summary, a safety apparatus for a stove or oven and a method of operation thereof are disclosed. The safety apparatus facilitates the method of turning on a burner of the stove or oven and automatically counting over a time interval in response to turning on the burner. The method further includes automatically stopping a flow of electrical current or combustible gas to the burner in response to the counting reaching an end of the time interval.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A method of automatically shutting off an electric burner of a stove or oven, said method comprising:
turning on an electric burner;
automatically counting over a time interval in response to said turning on an electric burner; and
automatically stopping a flow of electrical current to said electric burner in response to said counting reaching an end of said time interval.

2. The method of claim 1 further comprising selecting said time interval from a plurality of preset time intervals.

3. The method of claim 1 further comprising entering said time interval.

4. The method of claim 1 wherein said automatically stopping a flow of electrical current to said electric burner is accomplished by automatically opening a conductive electrical path to said electric burner in response to said counting reaching an end of said time interval.

5. The method of claim 4 further comprising re-closing said conductive electrical path in response to again turning on said electric burner.

6. The method of claim 1 wherein said automatically stopping a flow of electrical current to said electric burner is accomplished by automatically setting an electrical switch to a non-conductive position in response to said counting reaching an end of said time interval.

7. The method of claim 6 further comprising resetting said electrical switch to a conductive position in response to again turning on said electric burner.

8. A method of automatically shutting off a gas burner of a stove or oven, said method comprising:
turning on a gas burner;
automatically counting over a time interval in response to said turning on a gas burner; and
automatically stopping a flow of combustible gas to said gas burner in response to said counting reaching an end of said time interval.

9. The method of claim 8 further comprising selecting said time interval from a plurality of preset time intervals.

10. The method of claim 8 further comprising entering said time interval.

11. The method of claim 8 wherein said automatically stopping a flow of combustible gas to said gas burner is accomplished by automatically closing a gas flow path to said gas burner in response to said counting reaching an end of said time interval.

12. The method of claim 11 further comprising re-opening said gas flow path in response to again turning on said gas burner.

13. The method of claim 8 wherein said automatically stopping a flow of combustible gas to said gas burner is accomplished by automatically setting a gas valve to a non-flowing position in response to said counting reaching an end of said time interval.

14. The method of claim 13 further comprising re-setting said gas valve to a flowing position in response to again turning on said gas burner.

15. In a stove or oven for providing an electric current to an electric burner, the improvement comprising a safety apparatus comprising:
means for turning on an electric burner;
means for automatically counting over a time interval in response to activating said means for turning on said electric burner; and
means for automatically stopping a flow of electrical current to said electric burner in response to said means for automatically counting reaching an end of said time interval.

16. The safety apparatus of claim 15 further comprising means for selecting said time interval from a plurality of preset time intervals.

17. The safety apparatus of claim 15 further comprising means for entering said time interval.

18. The safety apparatus of claim 15 wherein said means for automatically stopping a flow of electrical current to said electric burner includes means for automatically opening a conductive electrical path to said electric burner in response to said means for automatically counting reaching an end of said time interval.

19. The safety apparatus of claim 18 further comprising means for re-closing said conductive electrical path in response to re-activating said means for turning on an electric burner.

20. The safety apparatus of claim 15 wherein said means for automatically stopping a flow of electrical current to said electric burner includes an electrical switch and means for automatically setting said electrical switch to a non-conductive position in response to said means for automatically counting reaching an end of said time interval.

21. The safety apparatus of claim 20 further comprising means for resetting said electrical switch to a conductive position in response to re-activating said means for turning on an electric burner.

22. In a stove or oven for providing gas to a gas burner, the improvement comprising a safety apparatus comprising:
means for turning on a gas burner;
means for automatically counting over a time interval in response to activating said means for turning on said gas burner; and
means for automatically stopping a flow of combustible gas to said gas burner in response to said means for automatically counting reaching an end of said time interval.

23. The safety apparatus of claim 22 further comprising means for selecting said time interval from a plurality of preset time intervals.

24. The safety apparatus of claim 22 further comprising means for entering said time interval.

25. The safety apparatus of claim 22 wherein said means for automatically stopping a flow of combustible gas to said gas burner includes means for automatically closing a gas flow path to said gas burner in response to said means for automatically counting reaching an end of said time interval.

26. The safety apparatus of claim 25 further comprising means for re-opening said gas flow path in response to re-activating said means for turning on a gas burner.

27. The safety apparatus of claim 22 wherein said means for automatically stopping a flow of combustible gas to said gas burner includes a gas valve and means for automatically setting said gas valve to a non-flowing position in response to said means for automatically counting reaching an end of said time interval.

28. The safety apparatus of claim 27 further comprising means for resetting said gas valve to a flowing position in response to re-activating said means for turning on a gas burner.
